(19) United States
(12) Patent Application Publication
(10) Pub. No.: US 2005/0262027 A1
(43) Pub. Date: Nov. 24, 2005

(54) Security system and method for deterring, preventing, and/or tracking of theft of the use of goods and services, particularly fuel at retail fueling stations

(75) Inventors: Ray J. Hutchinson, Houma, LA (US); Joseph M. Daniel, Tiffin, OH (US); Joseph C. Snyder, Tiffin, OH (US)

Correspondence Address: WITHROW & TERRANOVA, P.L.L.C., P.O. BOX 1287, CARY, NC, 27512, US

(73) Assignee: GILBARCO INC., Greensboro, NC (US)

(21) Appl. No.: 11/125,682

(22) Filed: May 10, 2005

Related U.S. Application Data
(60) Provisional application No. 60/569,681, filed on May 10, 2004.

(51) Int. Cl. G06F 19/00; G06F 17/00; A63F 13/00

(52) U.S. Cl. 705/75

(57) ABSTRACT

A system and method of preventing theft of the use of goods or services, particularly fuel dispensed from a fuel dispenser, comprised of providing a security system including a controller, a card reader that is operable to read data stored within an identification card and to report the identification data to the controller. A locking mechanism adapted to restrict access to the goods or services, wherein the locking mechanism is operable by the controller. The locking mechanism is engaged to restrict access to the goods or services until either payment is made, an identification card entered into the card reader, or both, by a user desiring access to the goods or services. The identification data on the card is verified in format and/or authenticity, and if verified, the locking mechanism is unlocked to allow access to the goods or services, such as fuel dispensed from a fuel dispenser.

### RELATED APPLICATION

This application claims the benefit and priority to U.S. Provisional Application No. 60/569,681, filed on May 10, 2004, entitled “System and method for a security system for preventing theft of the use of goods and services,” which is incorporated hereby by reference in its entirety.

### FIELD OF THE INVENTION

This invention relates in general to security systems and more particularly to a security system including a card reader adapted to accept identification information from a card to prevent the theft of the use of a related good or service, particular for use in a retail fueling station environment to prevent drive-offs for payment of fuel.

### BACKGROUND OF THE INVENTION

In particular to service station environments where customers fuel their own vehicles in a self-service environment, theft of fuel by non-payment and drive-offs is particularly a problem that causes substantial loss of revenue. Service station operators do have the ability to configure their systems to only allow fuel to be dispensed by a fuel dispenser after payment has been made first, up-front, known as “pre-pay.” However, some service station owners are hesitant to configure their fuel dispensers to require “pre-pay” due largely to the inconvenience and alienation to the customer.

For example, some customers may not want to have to go inside the convenience store to leave a deposit or pre-payment. These same customers may also not want to then go back outside to dispense fuel, and then go back inside the convenience store again a second time to settle up the difference between the deposit or prepayment and the actual charge for the fuel dispensed. Some service station operators are willing to take a chance on theft or drive offs by not implementing strict pre-pay rules on the fuel dispensers in fear that doing so might alienate customers, but the theft or drive-offs that occur as a result cost the service station significant losses in revenue profits thereby putting the service station owner in a predicament in how they decide to handle payment for their customers.

One solution to this problem has been possible due to the advent of credit and debit card presentation and payment at the fuel dispenser, also known as a CRIND®-equipped fuel dispenser in the case of Gilbarco's fuel dispensers, the assignee of the present invention. A CRIND®-equipped fuel dispenser can be configured to require pre-payment for fuel, but the system can be configured to be overridden to allow fueling if a credit or debit card is presented and authorized. Thus, this solves part of the problem in that customers having and desiring to pay for fuel using their credit or debit card can do so without having to go inside the convenience store to pre-pay and/or leave a deposit even if the service station is configured for pre-payment for cash transactions. However, not all customers have a credit or debit card, and a substantial amount of service station customers still desire to use cash for payment.

In order to prevent or deter drive-offs, some service station operators have employed cameras that are used by in-store operators. The cameras are used to view customers at the fuel dispensers and to record the license plate of a vehicle if a drive off occurs. However, problems exist with these systems. For example, such systems require the operator to quickly detect a drive off, and then capture a license plate number, which is very difficult due to the reaction time required between detection of drive off and before the vehicle departs from the service station. If a camera system is employed that can automatically recognize and decipher license plate numbers, such systems rely on optical sight and detection which are costly and imperfect and may not be able to readably detect a license plate. Further, the customer that dispensed fuel and drove off may not be the actual owner the car, and thus the true owner of the car cannot necessarily be held responsible legally or due to lack of evidence.

Therefore, there exists a need to provide a system and method of allowing a service station operator to not require pre-payment for cash transactions or other transactions where payment cannot be presented at the dispenser before dispensing is authorized, but still provide a manner of deterring, preventing and/or capturing data of the offending customer in the event of a drive-off and/or to recover lost sales.

### SUMMARY OF THE INVENTION

A security system for preventing the theft of the use of goods or services, including fuel dispensed from a fuel dispenser. The security system includes a card reader that is operable to read identification card data. Identification card data is data that is reasonably certain to identify the user or customer or characteristics indicative of the identity of the user, is present in a common readable medium so that such can be universally used in different localities or regions, and is reliable to be used from an evidentiary standpoint for law enforcement purposes. In this manner, the identification data can be used to detect fraud and/or is preferable since such identification card is widespread and possessed by all individuals that can legally operate a vehicle.

The card reader may be operable to read data stored in a variety of media and media technologies. In one embodiment, the identification card data is read from a state issued identification card in a known data format that may be read by the card reader when the identification card is inserted into the card reader. In a further embodiment, the identification card data is read from a state issued driver's license. The stated issued driver's license may include the person's name, address, date of birth, gender, driver's license number, digital photograph, signature and physical security features to prevent tampering, counterfeiting or duplication of the document for fraudulent purposes.

The card reader is communicably connected to a controller. The controller is operable to receive the identification card data from the card reader. The controller is operable to store and retrieve data from a memory device. The controller is further operable to store and retrieve the identification card data in the memory device. Preferably, the controller may be operable to store multiple instances of the identification card data within a user identification card database stored within the memory device. Additionally, information about the goods or services that have been requested, such as the location and time and date of the request may be stored with the identification card data in the user identification database so that the identification card data may later be matched to a particular attempted sale or transaction. It will be appreciated that the controller may only store the current or most recent identification card data within the memory device and the invention may then be practiced without the user identification database.

Access to the data stored within the user identification card database may be restricted by the controller, such that only certain data may be retrievable from the memory device or the controller. Access to the data stored within the user identification card database may also be restricted by password or by encryption technology, such that only certain users, such as law enforcement officers, may retrieve the data stored in the user identification card database. The controller and/or the memory device may be configured such that the controller may write data to the memory device, but the controller and/or memory device will only retrieve data from the user identification card database for a user that is verified as an authorized user. For example, at least a portion of the data from the user identification card database may only be retrievable from the security system by a member of a law enforcement agency that enters a password or other verification code into the controller. Thus, the security system 10 may record identification card data with minimal risk of personal information being improperly collected or used by the operator of the security system.

The memory device may additionally contain an identification format database that contains stored acceptable identification data formats. The controller may access the identification format database to compare the format of identification card data read by the controller to the acceptable formats stored within the identification format database. If the controller locates an acceptable format in the identification format database that matches the identification card data read by the controller, then the controller has verified that the identification card data is in a valid format and the controller may store the identification card data 14 to the identification card database. In a preferred embodiment, the identification format database contains the format for all U.S. state issued driver's licenses.

The controller may further verify the identification card data against an external data source, such as an identification database. The controller may be communicably connected to the identification database, such that the controller may not only verify the format, but also the authenticity or accuracy of the identification card data. It will be appreciated that the controller may store the identification card data within the memory and verify the identification card data against the identification format database and/or the identification database simultaneously or in any order.

The controller is further operable to control a locking mechanism. The locking mechanism is operable to restrict access to goods or services. The locking mechanism may be any mechanism that prevents the distribution of goods or services, and may preferably be electrical and/or mechanical. The controller is operable to engage and release the locking mechanism. In a preferred embodiment, the locking mechanism is engaged until the controller commands the locking mechanism to release, allowing a user to use the desired goods or services. The controller issues such a command to release the locking mechanism after receiving identification card data that is verified and stored in any manner described above.

The locking mechanism is operable to allow at least one pump 28 to prevent or allow the release the contents of the at least one pump. In a preferred embodiment, the at least one pump includes at least one gasoline pump. It will be appreciated that the locking mechanism may be operable to prevent or allow access to any type of goods or services contained in any manner or in any type of container. It will further be appreciated that a card reader may be provided for each pump of the at least one pumps, or that a particular pump of the at least one pumps may be selected by a user when the user desires to use one of the at least one pumps.

In one operational embodiment, the locking mechanism is engaged to restrict access to the pumps. When access to the pumps is desired, an identification card, such as a driver's license, should be entered by a prospective user into the card reader. After the controller 16 receives an indication from the card reader that a card has been inserted and read by the card reader, the controller verifies the format of the identification card data read by the card reader after the identification card has been entered into the card reader. If the identification card data is verified by the controller by any verification method described above, the controller commands the locking mechanism to release, allowing the user access to at least one of the pumps. If the identification card data cannot be verified by the controller, the controller does not command the locking mechanism to release, and the locking mechanism continues to prevent access to the pumps.

Once the user is granted access to use one of the at least one pumps, the user must successfully pay for the use of the goods or services provided, i.e. the gasoline pumped from the at least one pump. If the user does not successfully pay for all of the goods or services used, the identification card data or the corresponding data stored in the identification card database may be used by the operator of the security system or by law enforcement officers or others to determine the identity of the user that has unlawfully absconded with the goods or services used. Thus, if a theft of the goods or services occurs, the identification card data of the user that permitted such use can be used to recover the loss of goods or services from the user. Additionally, the security system allows a user to request use of secured goods or services without the necessity of providing a credit card or other payment method prior to beginning the transaction. The security system, via the controller, may also generate an alarm to inform the operator of a non-payment or drive-off by the user as well as mark the identification data for such user in the identification card database and/or identification database. This allows the controller to reject a request for goods if the user comes back to the security system since the controller can determine if the customer has not paid in the past by checking the identification card data against the identification card database and/or identification database.

### BRIEF DESCRIPTION OF THE DRAWINGS

FIG. 1 is a schematic diagram of a security system for preventing the theft of the use of goods and services;

FIG. 2 is a flowchart illustration of the operation of the invention in accordance with one operational embodiment;

FIG. 3 is a schematic diagram of a retail service station environment containing elements of the security system illustrated in FIG. 1;

FIG. 4 is a schematic diagram of a fuel dispenser;

FIG. 5 is a schematic diagram of components provided as part of the fuel dispenser illustrated in FIG. 4 and the fuel dispenser's communication connectivity to the controller or site controller;

FIGS. 6A and 6B are flowchart illustrations of another operational embodiment of the present invention; and

FIGS. 7A and 7B are flowchart illustrations of another operational embodiment of the present invention for dispensing fuel at a fuel dispenser, like the fuel dispenser illustrated in FIG. 4.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

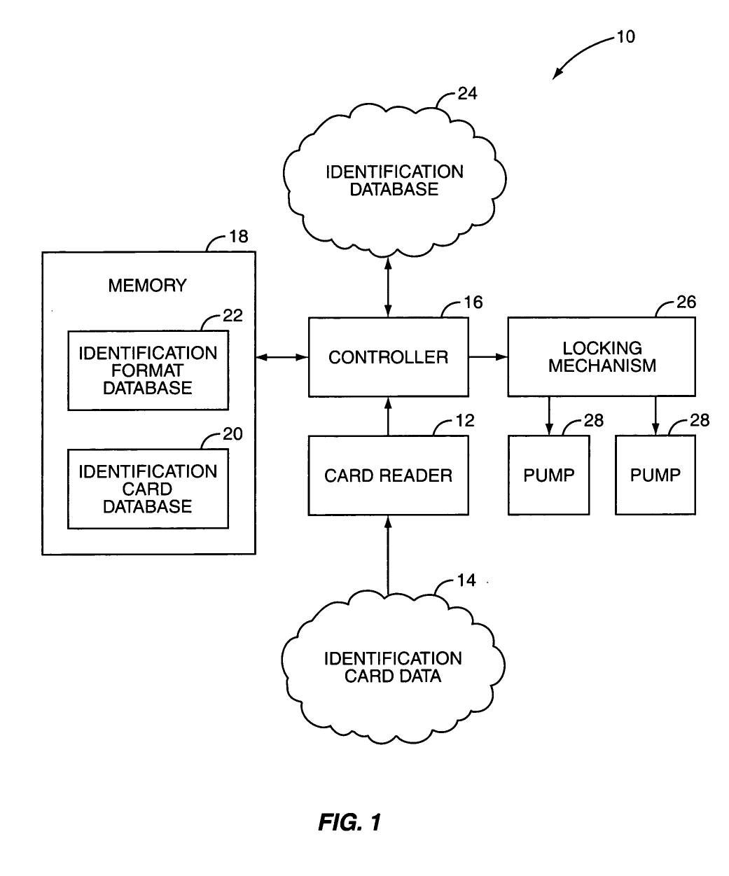

Referring now to the drawings, there is illustrated in FIG. 1 a security system, indicated generally as 10, for preventing the theft of the use of goods or services in accordance with the invention. The security system 10 includes a card reader 12 that is operable to read identification card data 14. Identification card data is data that is reasonably certain to identify the user or customer or characteristics indicative of the identity of the user, is present in a common readable medium so that such can be universally used in different localities or regions, and is reliable to be used from an evidentiary standpoint for law enforcement purposes. In this manner, the identification data can be used to detect fraud and/or is preferable since such identification card is widespread and possessed by all individuals that can legally operate a vehicle.

The card reader 12 may be operable to read data stored in a variety of media and media technologies, such as magnetic, bar code, optical, and radio-frequency based technologies, including but not limited to transponders, RFID, and Smartcard technologies. In a preferred embodiment, the identification card data 14 is read from a state issued identification card in a known data format that may be read by the card reader 12 when the identification card is inserted into the card reader 12. In a further preferred embodiment, the identification card data 14 is read from a state issued driver's license. The stated issued driver's license may include the person's name, address, date of birth, gender, driver's license number, digital photograph, signature and physical security features to prevent tampering, counterfeiting or duplication of the document for fraudulent purposes. It is important that the identification data

The card reader 12 is communicably connected to a controller 16. The controller 16 is operable to receive the identification card data 14 from the card reader 12. The controller 16 is operable to store and retrieve data from a memory device 18. The controller 16 is further operable to store and retrieve the identification card data 14 in the memory device 18. Preferably, the controller 16 may be operable to store multiple instances of the identification card data 14 within a user identification card database 20 stored within the memory device 18. Additionally, information about the goods or services that have been requested, such as the location and time and date of the request may be stored with the identification card data 14 in the user identification database 20 so that the identification card data 14 may later be matched to a particular attempted sale or transaction. It will be appreciated that the controller 16 may only store the current or most recent identification card data 14 within the memory device 18 and the invention may then be practiced without the user identification database 20.

Access to the data stored within the user identification card database 20 may be restricted by the controller 16, such that only certain data may be retrievable from the memory device 18 or the controller 16. Access to the data stored within the user identification card database 20 may also be restricted by password or by encryption technology, such that only certain users, such as law enforcement officers, may retrieve the data stored in the user identification card database 20. The controller 16 and/or the memory device 18 may be configured such that the controller 16 may write data to the memory device 18, but the controller 16 and/or memory device 18 will only retrieve data from the user identification card database 20 for a user that is verified as an authorized user. For example, at least a portion of the data from the user identification card database 20 may only be retrievable from the security system 10 by a member of a law enforcement agency that enters a password or other verification code into the controller 16. Thus, the security system 10 may record identification card data 14 with minimal risk of personal information being improperly collected or used by the operator of the security system 10.

The memory device 18 may additionally contain an identification format database 22 that contains stored acceptable identification data formats. The controller 16 may access the identification format database 22 to compare the format of identification card data 14 read by the controller 16 to the acceptable formats stored within the identification format database 22. If the controller 16 locates an acceptable format in the identification format database 22 that matches the identification card data 14 read by the controller 16, then the controller 16 has verified that the identification card data 14 is in a valid format and the controller 16 may store the identification card data 14 to the identification card database 20. In a preferred embodiment, the identification format database 22 contains the format for all U.S. state issued driver's licenses.

The controller 16 may further verify the identification card data 14 against an external data source, such as an identification database 24. The controller 16 may be communicably connected to the identification database 24, such that the controller 16 may not only verify the format, but also the authenticity or accuracy of the identification card data 14. It will be appreciated that the controller 16 may store the identification card data 14 within the memory 18 and verify the identification card data 14 against the identification format database 22 and/or the identification database 24 simultaneously or in any order.

The controller 16 is further operable to control a locking mechanism 26. The locking mechanism 26 is operable to restrict access to goods or services. The locking mechanism 26 may be any mechanism that prevents the distribution of goods or services, and may preferably be electrical and/or mechanical. The controller 16 is operable to engage and release the locking mechanism 26. In a preferred embodiment, the locking mechanism 26 is engaged until the controller 16 commands the locking mechanism 26 to release, allowing a user to use the desired goods or services. The controller 16 issues such a command to release the locking mechanism 26 after receiving identification card data 14 that is verified and stored in any manner described above.

The locking mechanism 26 is operable to allow at least one pump 28 to prevent or allow the release the contents of the at least one pump 28. In a preferred embodiment, the at least one pump 28 includes at least one gasoline pump. It will be appreciated that the locking mechanism 26 may be operable to prevent or allow access to any type of goods or services contained in any manner or in any type of container. It will further be appreciated that a card reader 12 may be provided for each pump of the at least one pumps 28, or that a particular pump of the at least one pumps 28 may be selected by a user when the user desires to use one of the at least one pumps 28.

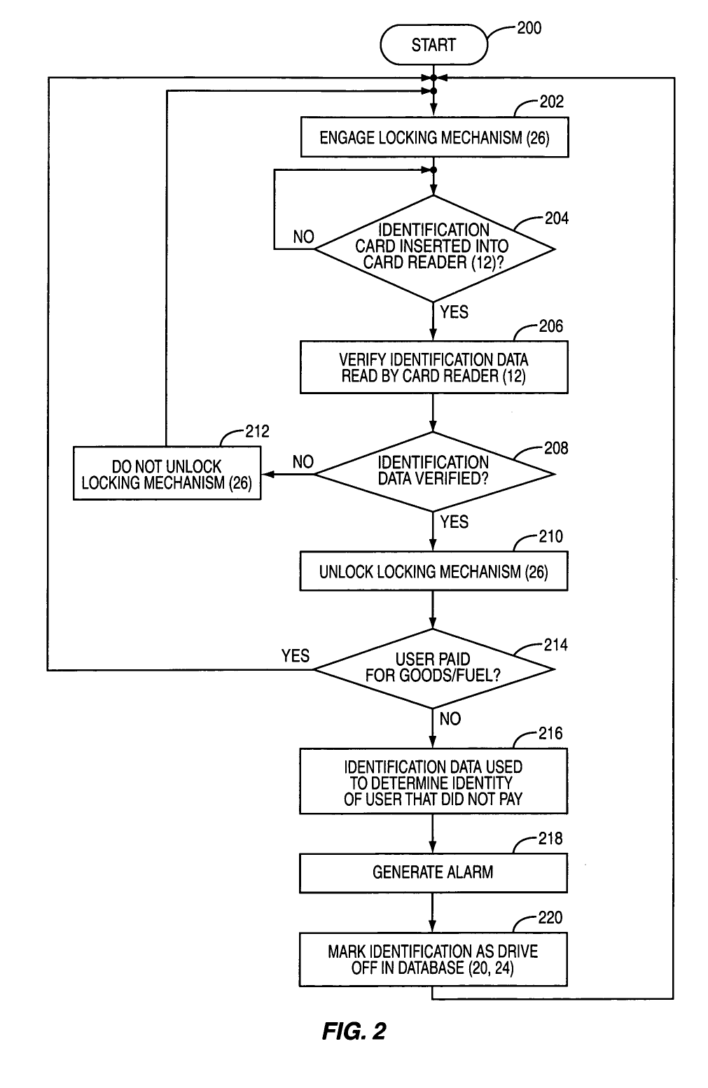

A method of preventing theft of the use of goods or services using the security system 10 will now be described and is illustrated in the flowchart in FIG. 2. The security system 10 including the card reader 12, the controller 16, the memory 18, and the locking mechanism 26 is provided to protect against theft of the use of the pumps 28. The process starts (step 200), and the locking mechanism 26 is engaged to restrict access to the pumps 28, as described above (step 202). When access to the pumps 28 is desired, an identification card, such as a driver's license, should be entered by a prospective user into the card reader 12. After the controller 16 receives an indication from the card reader 12 that a card has been inserted and read by the card reader (decision 204), the controller 16 verifies the format of the identification card data 14 read by the card reader 12 after the identification card has been entered into the card reader 12 (step 206). If the identification card data 14 is verified by the controller 16 by any verification method described above (decision 208), the controller 16 commands the locking mechanism 26 to release, allowing the user access to at least one of the pumps 28 (step 210). If the identification card data 14 cannot be verified by the controller 16, the controller 16 does not command the locking mechanism 26 to release, and the locking mechanism 26 continues to prevent access to the pumps 28 (step 212).

Once the user is granted access to use one of the at least one pumps 28, the user must successfully pay for the use of the goods or services provided, i.e. the gasoline pumped from the at least one pump 28 (decision 214). If the user does not successfully pay for all of the goods or services used, the identification card data 14 or the corresponding data stored in the identification card database 20 may be used by the operator of the security system 10 or by law enforcement officers or others to determine the identity of the user that has unlawfully absconded with the goods or services used (step 216). Thus, if a theft of the goods or services occurs, the identification card data 14 of the user that permitted such use can be used to recover the loss of goods or services from the user. Additionally, the security system 10 allows a user to request use of secured goods or services without the necessity of providing a credit card or other payment method prior to beginning the transaction. The security system 10, via the controller 16, may also generate an alarm to inform the operator of a non-payment or drive-off by the user (step 218) as well as mark the identification data for such user in the identification card database 20 and/or identification database 24 (step 220). This allows the controller 16 to reject a request for goods if the user comes back to the security system 10 since the controller 16 can determine if the customer has not paid in the past by checking the identification card data against the identification card database 20 and/or identification database 24.

Another advantage of the present invention is that if the identification card is a state or government issued driver's license, a person that is not authorized to drive a vehicle may not be able to purchase fuel if all dispensing systems are required to read the identification card as a prerequisite to allow fueling. This may prevent or cut down on the number of unauthorized, illegal, unlicensed, or persons having revoked licenses, from driving a vehicle.

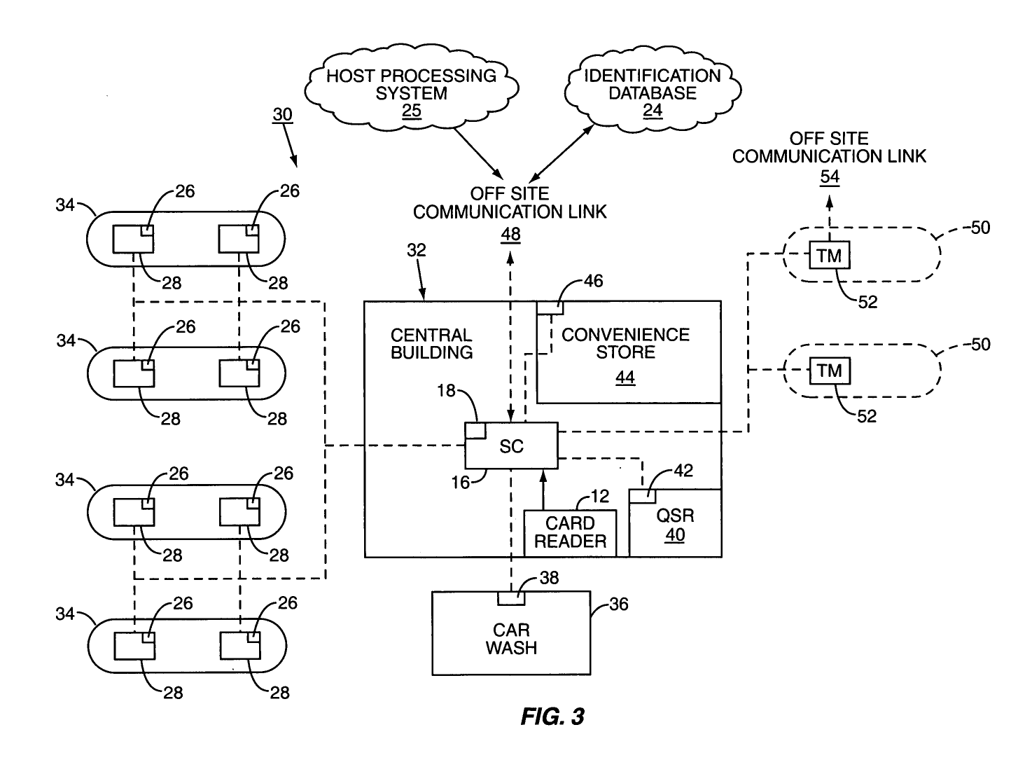

FIG. 3 illustrates more of the environment for use of the security system 10 in a retail fueling environment, or just fueling environment. Fueling environments come in many different designs. FIG. 3 illustrates a conventional exemplary fueling environment 30. Such a fueling environment 30 may comprise a central building 32, a plurality of fueling islands 34, and a car wash 36 for example.

The central building 32 need not be centrally located within the fueling environment 30, but rather is the focus of the fueling environment 30, and may house a convenience store 44 and/or a quick serve restaurant 40 therein. Both the convenience store 44 and the quick serve restaurant 40 may include a point of sale 42, 46, respectively. The central building 32 may further house the controller 16, which may be a site controller (SC) 16, which in an exemplary embodiment may be the G-SITE® sold by Gilbarco Inc. of Greensboro, N.C. The site controller 16 may control the authorization of fueling transactions and other conventional activities as is well understood. The site controller 16 may be incorporated into a point of sale, such as point of sale 42, 46, if needed or desired, such that the site controller 16 also acts as a point of sale device. The memory 18, comprising the identification format database 22 and the identification card database 20, may be provided as part of the site controller's memory 18 as illustrated in FIG. 3.

Further, the site controller 16 may have an off site communication link 48 allowing communication with a remote location for credit/debit card authorization via a host processing system 25, and the identification database 24, content provision, reporting purposes or the like, as needed or desired. The off site communication link 48 may be routed through the Public Switched Telephone Network (PSTN), the Internet, both, or the like, as needed or desired.

The car wash 36 may have a point of sale 38 associated therewith that communicates with the site controller 16 for inventory and/or sales purposes. The car wash 36 alternatively may be a stand alone unit. Note that the car wash 36, the convenience store 44, and the quick serve restaurant 40 are all optional and need not be present in a given fueling environment.

The fueling islands 34 may have one or more pumps 28 or fuel dispensers 28 positioned thereon. The fuel dispensers 28 may be, for example, the ECLIPSE® or ENCORE® fuel dispenser sold by Gilbarco Inc. of Greensboro, N.C. The fuel dispensers 28 are in electronic communication with the site controller 16 through a LAN, pump communication loop, or other communication channel or line, or the like.

The fueling environment 30 also has one or more underground storage tanks 50 adapted to hold fuel therein. As such, the underground storage tank 50 may be a double-walled tank. Further, each underground storage tank 50 may include a liquid level sensor or other sensor (not shown) positioned therein. The sensors may report to a tank monitor (TM) 52 associated therewith. The tank monitor 52 may communicate with the fuel dispensers 28 (either through the site controller 16 or directly, as needed or desired) to determine amounts of fuel dispensed, and compare fuel dispensed to current levels of fuel within the underground storage tanks 50 to determine if the underground storage tanks 50 are leaking. In a typical installation, the tank monitor 52 is also positioned in the central building 32, and may be proximate the site controller 16.

The tank monitor 52 may communicate with the site controller 16 and further may have an off site communication link 54 for leak detection reporting, inventory reporting, or the like. Much like the off site communication link 48, the off site communication link 54 may be through the PSTN, the Internet, both, other communication line, or the like. If the off site communication link 48 is present, the off site communication link 54 need not be present and vice versa, although both links may be present if needed or desired. As used herein, the tank monitor 52 and the site controller 16 are site communicators to the extent that they allow off site communication and report site data to a remote location.

For further information on how elements of a fueling environment 10 may interact, reference is made to U.S. Pat. No. 5,956,259, which is hereby incorporated by reference in its entirety. Information about fuel dispensers may be found in commonly owned U.S. Pat. Nos. 5,734,851 and 6,052,629, which are hereby incorporated by reference in their entirety. Information about car washes may be found in commonly owned U.S. Patent Application Publication No. 2004/0079799, entitled “Service Station Car Wash,” which is hereby incorporated by reference in its entirety. An exemplary tank monitor 52 is the TLS-350R manufactured and sold by Veeder-Root. For more information about tank monitors 36 and their operation, reference is made to U.S. Pat. Nos. 5,423,457; 5,400,253; 5,319,545; and 4,977,528, which are hereby incorporated by reference in their entireties.

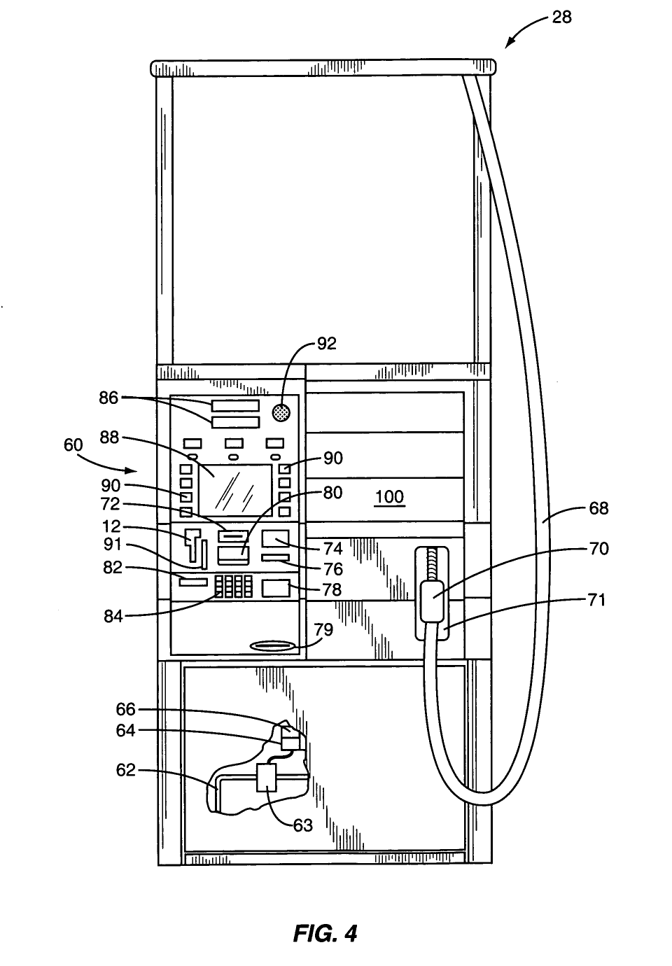

FIG. 4 illustrates one embodiment of the fuel dispenser 28 that is noted in FIGS. 1 and 3 above as a system which may require or obtain identification data via an identification card reader to authorize and/or report fraud or drive-offs in a fueling environment.

As illustrated in FIG. 4, a fuel dispenser 28 is shown constructed according to the present invention with a user interface 60 and a fuel delivery system. The delivery system provides a fuel delivery path from an underground storage tank 50 to a vehicle. The delivery path includes a fuel delivery line 62 having a volumetric or flow meter 64. The meter 64 may contain a pulser generator 66 that generates pulses indicative of the flow rate and/or volume of fuel delivered. A valve 63 under electronic control may also be provided in the fuel delivery line 62 so that fuel can be allowed and disallowed to be dispensed as discussed further below in this application.

The fuel delivery line 62 fluidly communicates with a fuel delivery hose 68, which extends outside the dispenser 28 and has a delivery nozzle 70. The delivery nozzle 70 provides manual control of fuel delivery to the vehicle. The delivery nozzle 70 is contained inside a housing that includes a pump handle 71 or other device to detect when the nozzle 70 has been removed an thus a request for refueling is being made by a customer.

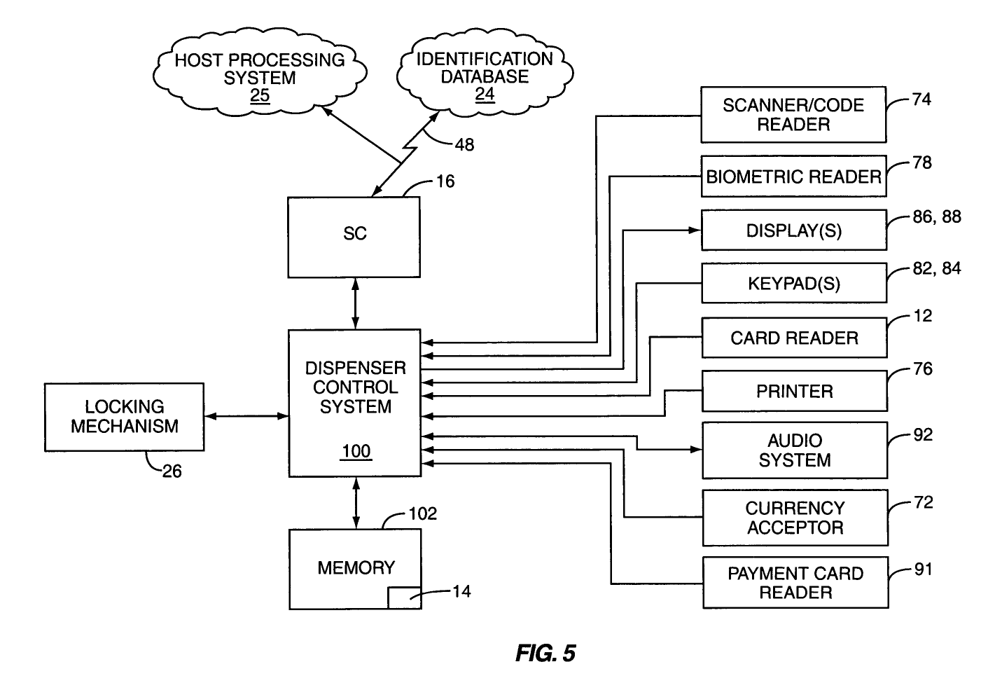

The dispenser 10 also includes a control system 100 (also illustrated in more detail in FIG. 5) having one or more controllers and associated memory 102 (illustrated in FIG. 5). The control system 100 operates to control the dispenser interface 60 and the fuel delivery system. The dispenser interface 60 will include various combinations of subsystems to facilitate customer interaction with the dispenser 28 and communication between the dispenser 28 and local and remote systems, such as the site controller 16, host processing system 25 and/or identification database 24. The memory 102 of the control system 100 may include the identification card database 14.

In one embodiment of the present invention, the dispenser 28 is equipped with the identification card reader 12, a payment card reader 91, a cash acceptor 72, and printer 76. The payment card reader 91 may be any kind of reader, including magnetic stripe, optical, etc., and the payment card reader 91 and identification card reader 12 may be provided as the same reader if the data input mediums accepted for the identification card reader 12 are the same as for the payment card reader 91. The payment card reader 91 is typically for a credit or debit card for payment of fuel.

With these options, the dispenser control system 100 may read data from the magnetic strip of a card inserted into the payment card reader 91 as well as account for cash received from a customer during a transaction. As shown in FIG. 5, such financial information is typically communicated to the site controller 16. The site controller 16 generally communicates with a host processing system 25, such as an account verification authority, to ascertain whether a transaction proposed to be charged or debited from an account associated with the card inserted in the payment card reader 91 is authorized. For transactions receiving cash through the cash acceptor 72, an amount of cash received by the dispenser 28 is forwarded to the site controller 16 for accounting. A receipt of any transaction occurring at the dispenser is printable using a printer 76.

The dispenser 28 may include one or more displays, such as a transaction display 86 and a graphics display 88. The transaction display 86 displays the amount of fuel dispensed and the price to be charged to the customer. The graphics display 88 is preferably a liquid crystal display or cathode-ray tube configured to display graphics, video, or a combination thereof, and instructions to the customer for interaction with the dispenser 28. Either of these displays may be associated with one or more keypads, such as soft keys 90 or the hard keypad 84. Either of these keypads may be integrated with the graphics display 88 to provide a touch-activated interface.

The dispenser 28 may also be equipped with a scanner or code reader 74, such as a bar code reader, to receive additional information from a customer. The information may come from a printout received from another location, or a code on an associated card or like medium. The dispenser 28 may also include a biometric reader 78 for reading fingerprints, retinal information, or like biometric indicia to help identify a user and facilitate secure transactions, including identification of the customer for fraud prevention and drive off reporting similar to that of the identification card data discussed above.

The dispenser 28 may also be equipped with an audio system with one or more speakers 92 in order to provide various beeps, tones and audible messages to a customer. These messages may include warnings, instructions, and advertising.

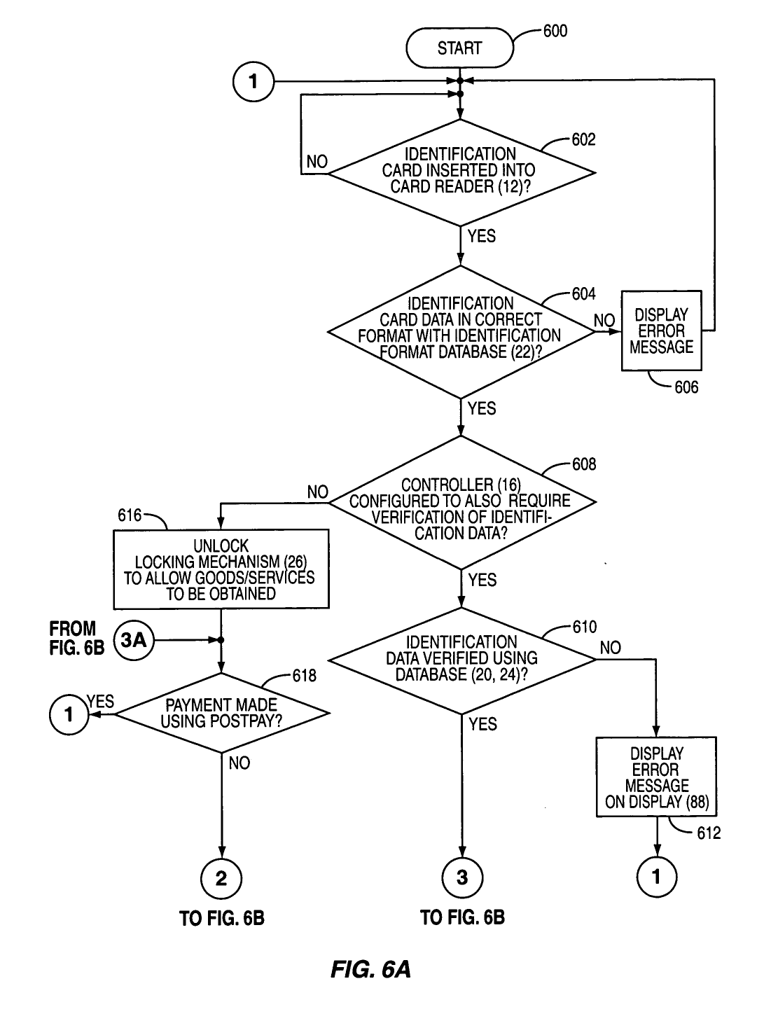

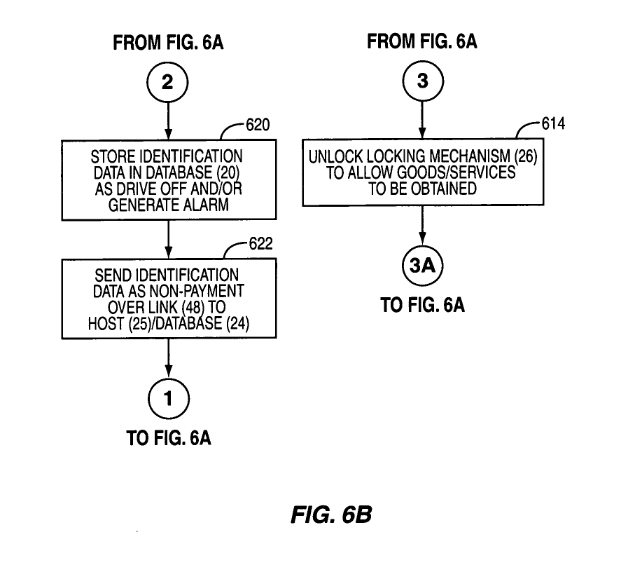

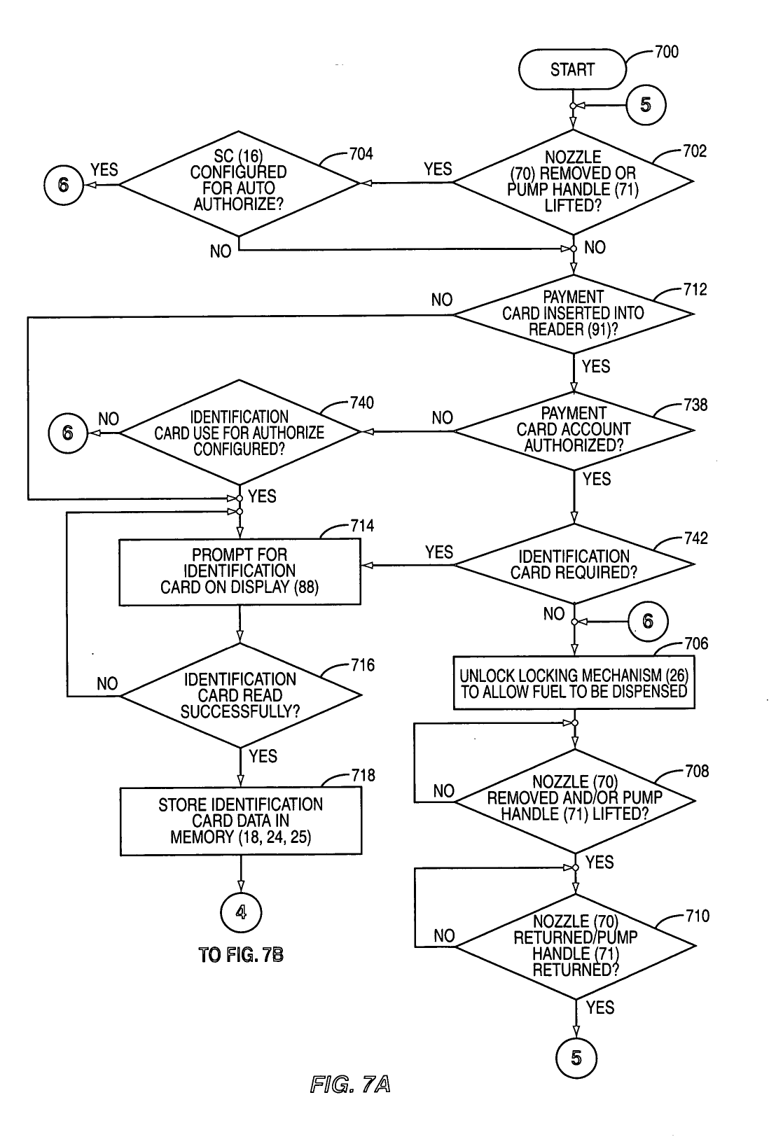

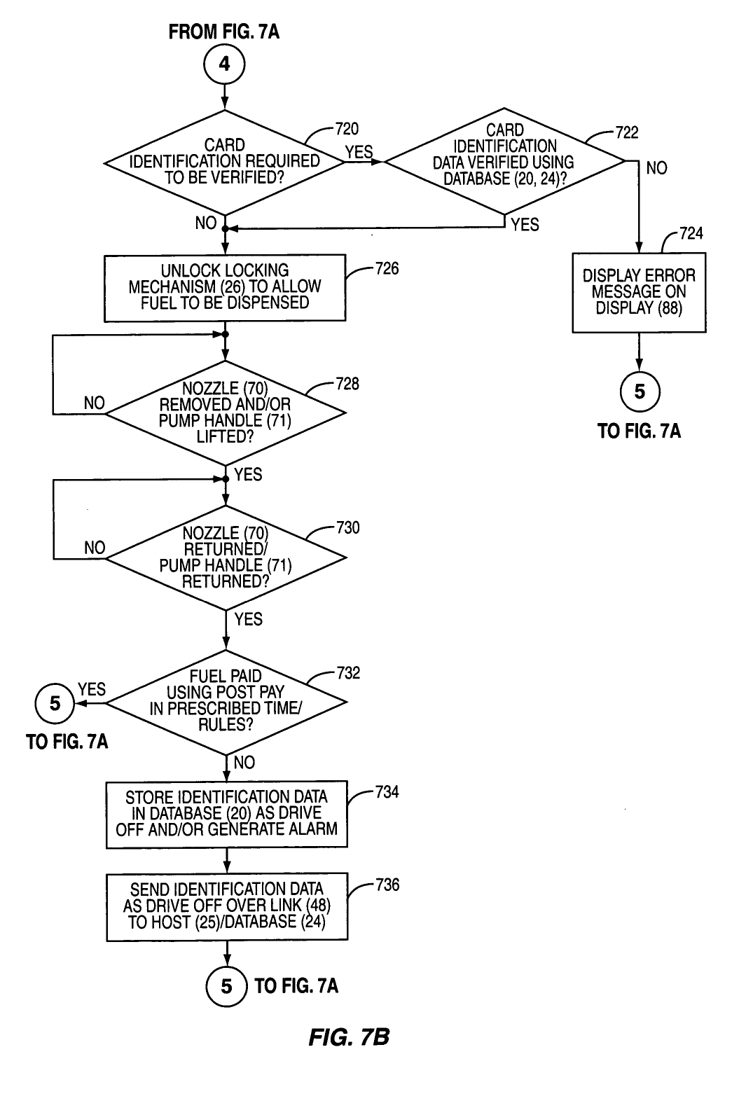

With the above described, several other operational embodiments of the present invention with respect to a service station 30 and fuel dispensers 28 will not be described in the flowcharts in FIGS. 6A and 6B, and 7A and 7B.

In the operational embodiment illustrated in the flowcharts of FIGS. 6A and 6B, the site controller 16 can be configured where either the identification data from the identification card inserted into the card reader 12 is verified or not. If required to be verified, the site controller 16 does not unlock the fuel dispenser 28 to allow fueling until the identification data is not only properly read and in the correct format, but verified using a database 20, 24. If not required to be verified, but simply read, the site controller 16 will unlock the fuel dispenser 28 to allow fueling if the identification data from the identification card is successfully read and in an allowable format. In either aforementioned case, if the user or customer does not then later pay for the fuel in a post pay arrangement within prescribed rules, such as in a certain amount of time for example, the identification data will be used to identify the user that has not paid and/or drove off, and alarms, reports and other notifications will be made.

The process starts (step 600), and the control system 100 waits until an identification card has been inserted into the card reader 12 (decision 602). Once an identification card has been inserted and read by the card reader 12, the identification card data obtained is communicated to the site controller 16, where it determines if the identification card data was properly read and is a correct format by comparing such to the identification format database 22 (decision 604). If not, the site controller 16 communicates to the dispenser control system 100 to cause the control system 100 to display an error message on the display 88 informing the user that the identification card was not successfully read or not an accepted format (step 606), and the process returns to waiting for the user to insert the identification card into the card reader 12 again (decision 602).

If the site controller 16 is able to verify that the identification data was successfully read and is of an acceptable format (decision 604), the site controller 16 determines whether it is configured to also require verification of the identification data before unlocking the pump 28 and allowing dispensing (decision 608). In this manner, the operator of the site controller 16 can configure it such that either verification is required or not. It may be advantageous to not require verification in order to improve efficiency and throughput of the service station 30 in the user being able to dispense fuel more immediately, but with the security that the user's identification data is captured in the event the user does not pay after dispensing properly and/or drive offs.

If the identification data is required to be verified, such as to ensure that the identification data is correct and that the identification data has not been previously associated with a failure to pay and/or drive off as discussed previously above, the site controller 16 either verifies the data using the identification card database 20 and/or the identification database 24 located remotely to determine if the identification data is valid and/or authorized (decision 610). If not, the site controller 16 communicates same to the dispenser control system 100, which in turn displays an error message on the display 88 to the user and does not unlock the pump 28 for dispensing (step 612), and the process returns to wait for an identification card to be inserted into the card reader (602).

However, if the identification data is verified (decision 610), then the site controller 16 will inform the dispenser control system 100 to unlock the locking mechanism 26, which may be flow control valve 63 as illustrated in FIG. 4, to allow dispensing of fuel (step 614 in FIG. 6B). The site controller 16 may also have previously downloaded this configuration information to the dispenser control system 100 so that the dispenser control system 100 does not have to communicate with the site controller 16 to determine if verification is not required.

If the site controller 16 is not configured to require verification of the identification data (decision 608), then site controller 16 will inform the dispenser control system 100 to unlock the locking mechanism 26, which may be flow control valve 63 as illustrated in FIG. 4, to allow dispensing of fuel (step 616). Again, the site controller 16 may also have previously downloaded this configuration information to the dispenser control system 100 so that the dispenser control system 100 does not have to communicate with the site controller 16 to determine if verification is not required.

In either case, whether the verification of the identification data as a further step is required or not, if the customer or user does not pay for the fuel dispensed using a post pay function properly (decision 618), the dispenser control system 100 and/or site controller 16 will store the identification data in database 20 as a drive off and/or generate an alarm (step 620). The site controller 16 may also send the identification data over link 48 to the host processing system 25 and/or identification database 24 to report the drive off, send such to law enforcement authorities automatically or with human intervention, and/or store the identification data as a drive off so that future verifications performed on the identification data can be denied, reported, and/or the location of the user tracked (step 622). The site controller 16 may use a variety of methods to determine if a user or customer has properly made a post pay when the identification data is not required to be verified. For example, the site controller 16 could determine if the user or customer has not paid for fuel within a prescribed period of time after the fueling transaction has finished, or after a certain number of fueling transactions have occurred on the same dispenser 28 previously used by the user.

FIGS. 7A and 7B illustrate yet even another operational embodiment of the present invention that is particularly suited for a service station environment 30. These flowcharts illustrate a system whereby the site controller 16 and/or fuel dispenser 28 may be configured to allow fueling without reading and/or verifying of identification data from an identification card in all instances, allow fueling without reading and/or verifying of identification data from an identification card in all instances if a payment card is presented, such as a credit or debit card, with either verifying or not verifying the payment card, and only allowing fuel to be dispensed by requiring reading of an identification card in all instances. The primary goal of the present invention is to deter non-payment and/or drive offs where post payment is allowed, so it may not be necessary to require an identification card if a credit or debit card is used since the user will have prepaid, or if the operator of the service station 30 desires to not require or disable the requirement of an identification card being read for any reason.

The process starts (step 700), and the dispenser control system 100 waits until the nozzle 70 is either removed and/or the pump handle 71 is lifted by the user or customer signifying a request to dispense fuel (decision 702). Once this occurs, the control system 100 determines if the system, via the site controller 16, is configured for automatic authorization of dispensing regardless of whether a payment card or identification is presented (decision 704). If so, the dispenser control system unlocks the locking mechanism 26 to allow fuel to be dispensed (step 706), and waits until the nozzle 70 is returned back and/or the pump handle 71 returned down to its original position (decision 710). Once returned, the fueling transaction has been terminated, and the system repeats the process (step 702).

If the site controller 16 and/or dispenser 28 are not configured for automatic authorization (decision 704), the dispenser control system 100 determines if a payment card, such as a credit or debit card, has been inserted into the card reader 91 (decision 712). If not, the dispenser control system prompts the user to enter their identification card into the card reader 12 on the display 88 (step 714). Once the identification card is successfully read by the card reader 12 and the format compared against known and acceptable formats by the site controller 16 using identification format database 22 (decision 716), the identification card data is stored in memory in one or more databases 18, 24, 25 (step 718). If the site controller 16 and/or dispenser control system 100 requires the identification card data to be verified (decision 720), the site controller 16 verifies the identification using either the local database 20 or the remote identification database 24 (decision 722), and if not valid or allowed, the dispenser control system 100 displays an error message on the display 88 (step 724).

If valid or allowed, the dispenser control system 100 allows fueling once the nozzle 70 and/or pump handle 71 are lifted (decision 728), by unlocking the locking mechanism (step 726) (similar to step 706 as previously described above), and waiting until the nozzle 70 is returned and/or the pump handle 71 put down (decision 730). Once returned, the user then pays for the fuel using a post payment process. If the site controller 16 determines that the user has not properly paid for the fuel, as described previously, with the prescribed rules or time limit (decision 732), the identification data is stored in database 20 as a drive-off or non-payment user and/or an alarm is generated to alert operators at the service station 30 (step 734). Further, the identification data may be sent over communication link 48 to the host processing system 25 and/or identification database 24 to report such to operators, and/or law enforcement authorities, either automatically or by human intervention, and/or stored so that if the same identification data is read for a subsequent transaction, it can be recorded, denied, and/or the location of the user tracked (step 736).

If in decision 712 the user did insert a payment card, such as a credit or debit card for payment of fuel, the dispenser control system 100 receives the account information from the payment card reader 91 and determines if the card account is authorized via communication with the host processing system 25 (decision 738). If not, the site controller 16 may be configured to still allow the user to dispense fuel and pay after fueling if an identification card is presented or not (decision 740). If not, the dispenser control system 100 will unlock the locking mechanism 26 to allow dispensing by going to step 706, as previously described above. If an identification card data is required in decision 740, since the payment card was not authorized for payment, the process will go to step 214 to read, verify the format, and/or verify the identification card data just as previously described above before fueling can occur.

If in decision 738 the payment card was authorized, the site controller 16 and/or dispenser 28 may still be configured to require reading of an identification card for fueling (decision 742). If so, the process goes to decision 714 to read, verify the format, and/or verify the identification card data just as previously described above before fueling can occur. If not, the process will go ahead and allow fueling by the dispenser control system 100, unlocking the locking mechanism 26 to allow the dispenser 28 to dispense fuel by going to step 706, as previously described above.

Those skilled in the art will recognize improvements and modifications to the preferred embodiments of the present invention. All such improvements and modifications are considered within the scope of the concepts disclosed herein and the claims that follow.

1-2. (canceled)

3. A dispensing system that allows a user to dispense fuel to a vehicle in response to verification of identification card data from an identification card, comprising:
a) a controller communicatively coupled to a first database and a second database; and
b) a fuel dispenser, comprising:
i) a hose and nozzle that dispenses the fuel to the vehicle;
ii) a card reader coupled to the controller, wherein the card reader is adapted to receive identification card data; and
c) a locking mechanism coupled to the controller, wherein the locking mechanism controls the dispensing of fuel to the hose and nozzle;
d) wherein the controller is adapted to:
i) receive the identification card data from the card reader;
ii) verify the identification card data against the first database;
iii) unlock the locking mechanism to allow dispensing of fuel if the identification card data is verified; and
iv) mark the identification card data in the second database, or generate an alarm, or both, if the user does not successfully pay for the fuel.

4. The system of claim 3, wherein the controller is located within the fuel dispenser.

5. The system of claim 3, wherein the controller is located apart from the fuel dispenser.

6. The system of claim 3, wherein the controller is further adapted to verify the identification card data against the first database by verifying the format of the identification card data against an identification format database.

7. The system of claim 3, wherein the controller is further adapted to verify the identification card data against the first database by verifying the authenticity of the identification card data against an identification database.

8. The system of claim 3, wherein the controller is further adapted to verify the identification card data against the first database by determining if the identification card data was previously marked in the second database as a result of the user not successfully paying for the fuel.

9. The system of claim 3, wherein the first database and the second database are a common database.

10. The system of claim 3, wherein the first database and the second database are distinct databases.

11. The system of claim 3, wherein the controller is further adapted to unlock the locking mechanism to allow dispensing of fuel if the controller is configured for automatic authorization.

12. The system of claim 3, further comprising a payment card reader coupled to the controller wherein the controller is adapted to receive payment card data from a payment card inserted into the payment card reader.

13. The system of claim 12, wherein the controller is further adapted to unlock the locking mechanism to allow dispensing of fuel if the payment card is authorized.

14. The system of claim 13, wherein the controller is further adapted to unlock the locking mechanism to allow dispensing of fuel if the controller is configured to not require verification of the identification card data to allow dispensing of fuel.

15. The system of claim 13, wherein the controller is further adapted to verify the identification card data against the first database by verifying the format of the identification card data against an identification format database, and by verifying the authenticity of the identification card data against an identification database.

16. The system of claim 3, wherein the controller is further adapted to unlock the locking mechanism to allow dispensing of fuel if the controller is configured to not require verification of the identification card data to allow dispensing of fuel.

17. The system of claim 3, wherein the controller is further adapted to generate a report if the user does not successfully pay for the fuel.

18. The system of claim 3, wherein the controller is further adapted to mark the identification card data in the second database, or generate an alarm, or both, if the user does not successfully pay for the fuel within a prescribed rule.

19. The system of claim 18, wherein the prescribed rule comprises successful payment within a prescribed amount of time.

20. The system of claim 3, wherein the second database is comprised from the group consisting of an identification database, an identification card database, and a host processing system.

21. The system of claim 3, wherein the controller is further adapted to store information about the fuel dispensed with the identification card data in the second database.

22. The system of claim 3, wherein the controller is further adapted to restrict access to the identification card data marked in the second database by password or encryption technology.

23. The system of claim 3, wherein the card reader is comprised from the group consisting of a magnetic stripe reader, an optical reader, and a radio-frequency reader.

24. The system of claim 3, wherein the identification card data contains data relating to the identity of the user.

25. The system of claim 3 wherein the identification card contains a common readable medium containing the identification card data.

26. The system of claim 3, wherein the identification card is a government issued identification card.

27. The system of claim 26, wherein the government issued identification card is a state issued driver's license.

28. The system of claim 27, wherein the state issued driver's license contains identification data comprised of data from the group consisting of a person's name, an address, a date of birth, a gender, a driver's license number, a digital photograph, a signature, and a physical security feature.

29. A method of allowing a user to dispense fuel to a vehicle in response to verification of identification card data from an identification card, comprising the steps of:
a) receiving the identification card data from a card reader;
b) verifying the identification card data against a first database;
c) unlocking a locking mechanism that controls the dispensing of fuel to allow dispensing of fuel if the identification card data is verified; and
d) marking the identification card data in a second database, or generating an alarm, or both, if the user does not successfully pay for the fuel.

30. The method of claim 29, wherein the step of verifying comprises verifying the format of the identification card data against an identification format database.

31. The method of claim 29, wherein the step of verifying comprises verifying the authenticity of the identification card data against an identification database.

32. The system of claim 29, wherein the step of verifying comprises verifying the identification card data against the first database by determining if the identification card data was previously marked in the second database as a result of the user not successfully paying for the fuel.

33. The method of claim 29, wherein the first database and the second database are a common database.

34. The method of claim 29, wherein the first database and the second database are distinct databases.

35. The method of claim 29, further comprising receiving payment card data from a payment card inserted into a payment card reader.

36. The method of claim 29, further comprising generating a report if the user does not successfully pay for the fuel.

37. The method of claim 29, wherein the step of marking comprises marking the identification card data in the second database, or generating an alarm, or both, if the user does not successfully pay for the fuel within a prescribed rule.

38. The method of claim 29, wherein the step of marking comprises marking the identification card data in the second database, or generating an alarm, or both, if the user does not successfully pay for the fuel within a prescribed amount of time.

39. The method of claim 29, wherein the second database is comprised from the group consisting of an identification database, an identification card database, and a host processing system.

40. The method of claim 29, further comprising storing information about the fuel dispensed with the identification card data in the second database.

41. The method of claim 29, further comprising restricting access to the identification card data marked in the second database by password or by encryption technology.

42. The method of claim 29, wherein the card reader is comprised from the group consisting of a magnetic stripe reader, an optical reader, and a radio-frequency reader.

43. The method of claim 29, wherein the identification card data contains data relating to the identity of the user.

44. The method of claim 29, wherein the identification card contains a common readable medium containing the identification card data.

45. The method of claim 29, wherein the identification card is a government issued identification card.

46. The method of claim 29, wherein the government issued identification card is a state issued driver's license.

47. The method of claim 46, wherein the state issued driver's license contains identification data comprised of data from the group consisting of a person's name, an address, a date of birth, a gender, a driver's license number, a digital photograph, a signature, and a physical security feature.
